(19) United States
(12) Patent Application Publication
(10) Pub. No.: US 2010/0101921 A1
(43) Pub. Date: Apr. 29, 2010

(54) Steering Wheel Mounted Control Using Touch Switch

(76) Inventors: David M. Howie, Foxboro, MA (US); Jeffrey P. Rudd, Foxboro, MA (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/527,367

(22) PCT Filed: Apr. 18, 2008
(86) PCT No.: PCT/US08/60772

§ 371 Date: Aug. 14, 2009

Related U.S. Application Data
(60) Provisional application No. 60/925,832, filed on Apr. 23, 2007.

(51) Int. Cl. H01H 9/00

(52) U.S. Cl. 200/61.54

(57) ABSTRACT

A combined mechanical and switch activation stalk provides a vehicle driver independent control of a vehicle system that heretofore has not been separately controllable, such as the turn signal system and the wiper and washer system. The lever may be moved to make a first input to the vehicle system and a touch pad incorporated into the body of the lever may be touched to signal a second input that either overrides an input made with movement of the activation stalk or to activate/deactivate the vehicle system in a manner not available with movement of the activation stalk.

### CROSS-REFERENCE TO RELATED APPLICATIONS

This application claims the benefit of U.S. Ser. No. 60/925,832, filed Apr. 23, 2007, and PCT Application PCT/US2008/060772, filed Apr. 18, 2008, the disclosures of which are incorporated herein by reference.

### STATEMENT REGARDING FEDERALLY SPONSORED RESEARCH OR DEVELOPMENT

N/A

### BACKGROUND OF THE INVENTION

The present invention is directed to a combined mechanical and touch switch for use with vehicles, such as a turn signal activation stalk or a wiper and washer activation stalk.

Automobile windshield washers are typically incorporated into the windshield wiper mechanical stalk switch attached to the steering column and arranged to be conveniently positioned for operation with minimal movement of the hand from the steering wheel. Typically the windshield is washed by pulling the lever towards the driver which also starts the wipers. Thus, it is not possible to spray washer fluid without also activation the wipers.

This integrated operation of the washer and wiper system poses a couple of drawbacks. First, if the wiper blades are initially dragged across a dry windshield there is a risk of scratching the glass if the windshield is dirty. Second, at highway speeds the washer sprays are often deflected downwards and hit the bottom of the viewed portion of the windshield. The action of the wiper immediately removes this water before it has time to run up the viewed portion of the windshield.

Automobile turn signals are typically operated by a mechanical stalk switch attached to the steering column and arranged to be conveniently positioned for operation with minimal movement of the hand from the steering wheel. Because these switches are mechanical switches, some movement of the mechanism is required to activate the turn signal. The mechanism is further complicated by its location in the steering column (which is already crowded with functions) and the frequent addition of other switches, such as headlight and cruise controls, in the same mechanism.

A further limitation to turn signals is the mechanical self-canceling mechanism. One limitation of the self-canceling mechanism is that there are certain positions of the steering wheel where the turn signal will not latch. This is a problem when the vehicle is already partly turned, i.e., the steering wheel is already rotated, when it is desired to turn on the turn signal. A further limitation is when the vehicle does not turn far enough to activate the canceling mechanism. In such a situation, the turn signal is not cancelled when the turn is complete.

### SUMMARY OF THE INVENTION

The inventors have found that a combined mechanical and touch switch (for example capacitance switch) control provides a vehicle driver independent control of a vehicle system that heretofore has not been separately controllable, such as the turn signal system and the wiper and washer system. The lever may be moved to make a first input to the vehicle system and a touch pad incorporated into the body of the lever may be touched to signal a second input that either overrides an input made with movement of the lever or to activate/deactivate the vehicle system in a manner not available with movement of the lever.

A combined mechanical switch and touch switch turn signal activation stalk allows a driver to activate the turn signal lamps of a vehicle without moving the turn signal lever. The inventors have discovered that a touch based switch, such as a capacitance based touch pad, mounted to the turn signal lever, that responds to driver contact allows the driver to signal a lane change or cancel an otherwise flashing turn signal lamp without having to physically move the turn signal. Similarly, the touch pad allows the driver to activate the turn signal system when movement of the turn signal lever would otherwise fail to do so, such as when the steering wheel is rotated.

Thus, it is an object of the invention to enable a driver to temporarily activate the turn signal system of a vehicle without mechanically moving the turn signal activation stalk.

It is a further object of the invention to allow touch based cancellation of a turn signal.

It is yet another object of the invention to allow the driver to overcome the shortcoming of the turn signal system that prevents the turn signal system from being mechanically activated when the steering wheel is rotated.

The inventors have found that the wiper and washer system of a vehicle can also be controlled using a combined mechanical switch and touch switch washer system control mounted to the steering column of the vehicle. By incorporating a touch based switch into an otherwise conventional activation stalk, the inventors have provided a mechanism that allows a driver to spray washing fluid onto the vehicle windshield without simultaneously activating the wipers of the vehicle.

Thus, it is an object of the invention to enable a driver to self-determine the amount of washing fluid that is sprayed onto the windshield of a vehicle before the wipers are activated to wipe away the washing fluid.

The present invention further allows the driver of a vehicle traveling at high speeds to lengthen the amount of time washing fluid is sprayed before the wipers are activated so that the washing fluid can creep up the windshield.

Various other features and advantages of the present invention will be made apparent from the following detailed description and the drawings.

### BRIEF DESCRIPTION OF THE DRAWINGS

FIG. 1 is a rear plan view of a steering column and wheel having a pair of combined mechanical and touch switch activation stalks mounted to the steering column according to one aspect of the present invention;

FIG. 2 a simplified schematic representation of a combined mechanical and touch switch turn signal activation stalk mounted to the steering column shown in FIG. 1 movable between a neutral position and either a left turn position and a right turn position, and having upper and lower touch sensors that cause temporary activation of turn signal lamps independent of the position of the activation stalk;

FIG. 3 is a simplified schematic representation of a combined mechanical and touch switch turn signal activation stalk mounted to the steering column shown in FIG. 1 according to another embodiment of the present invention and having a cancellation touch sensor to cancel activation of a turn signal lamp otherwise activated by upper or lower movement of the turn signal activation stalk and;

FIG. 4 is a simplified schematic representation of a combined mechanical and touch switch wiper and washer assembly activation stalk mounted to the steering column of FIG. 1 movable to activate wipers and having a touch sensor that when touched causes washer fluid to be sprayed onto the windshield independent of activation of the wipers.

### DETAILED DESCRIPTION OF THE INVENTION

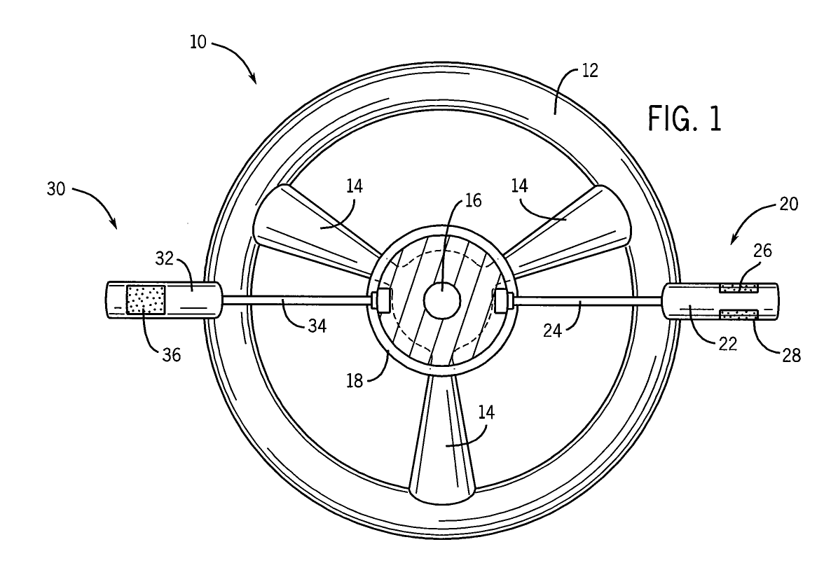

FIG. 1 shows a steering wheel 10 for use with a vehicle and having an annular rim 12 with inwardly extending spokes 14 radially spaced from one another and connected in a conventional manner to a steering shaft 16 centrally housed within steering column 18. Rotation of the steering wheel 10 causes a pinion gear (not shown) connected at a distal end of the steering shaft 16 to linearly translate a rack, or other similar mechanism, to turn the vehicle, as known in the art.

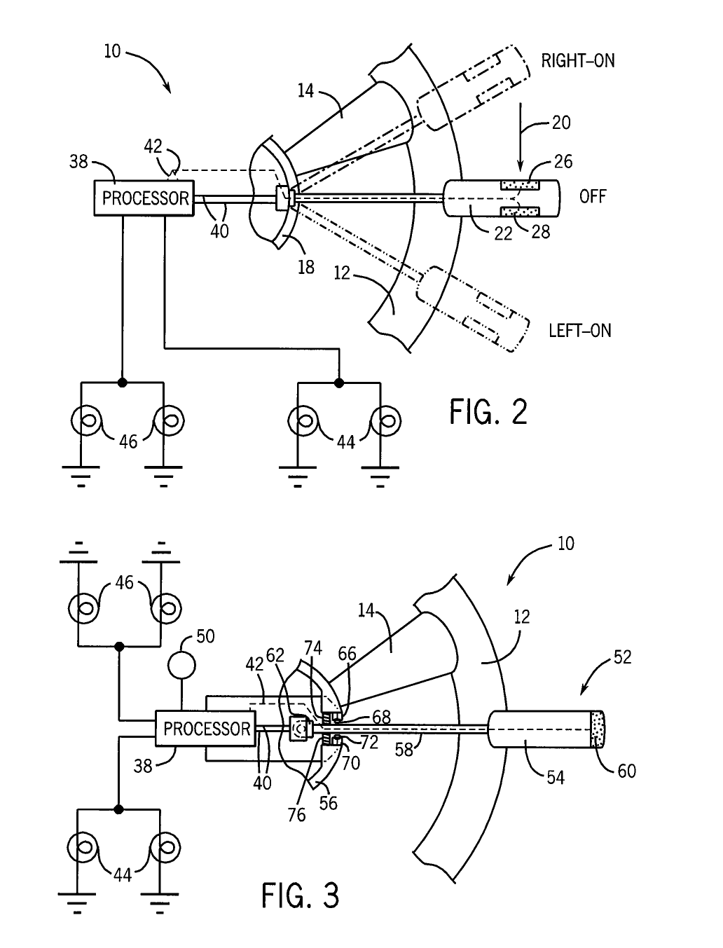

Two combined mechanical and touch switch controls 20 and 30 are mounted to the steering column 18. Specifically, a turn signal activation stalk 20 includes a handle 22 that is connected to the steering column 18 using a connector arm 24. Preferably, the connector arm 24 is of sufficient length to extend the handle 22 past the edge of the annular rim 12 of the steering wheel 10. An upper touch pad 26 and a lower touch pad 28 are carried by the handle 22. Preferably, the upper and lower touch pads 26, 28 are electrodes of capacitance switches, but it is understood that other types of touch sensors could be used, such as resistance based sensors. As will be described with respect to FIG. 2 below, the turn signal activation stalk 20 may be pivoted at the steering column 18 between an OFF position (in a generally horizontal position) and either a LEFT-ON position or a RIGHT-ON position (pivoted down or pivoted up) to control the turn signal lamps of the vehicle accordingly. Further, the turn signal lamps may also be controlled with inputs to the upper and lower touch pads 26, 28.

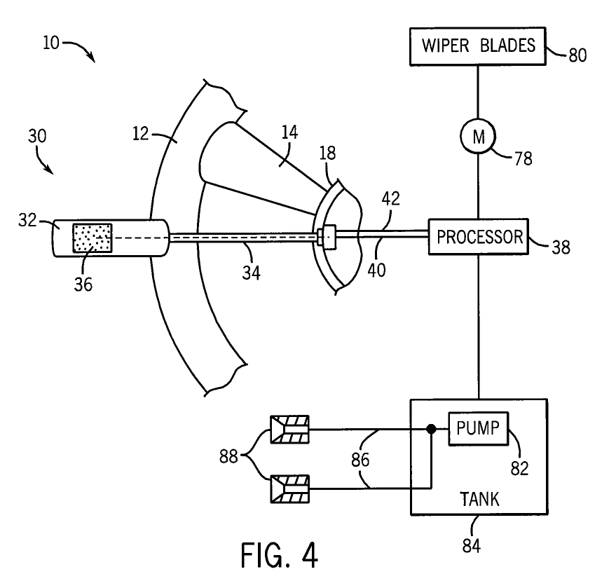

Mounted opposite the turn signal activation stalk 20 is a washer system activation stalk 30 that includes a handle 32 connected to the steering column 18 using connector arm 34. As shown in FIG. 1, the backside of the handle 32 includes a touch pad 36. As will be described with respect to FIG. 4, the washer system activation stalk 30 can be mechanically pulled toward the driver to control the wiper blades of the vehicle. The touch pad 36 allows a driver to separately control the washer system of the vehicle so that washer fluid may be sprayed onto the windshield of the vehicle independently of the activation of the wiper blades.

Referring now to FIG. 2, one representative turn signal activation stalk 20 is partly of conventional design in that the turn signal activation stalk 20 may be mechanically pivoted from a turn signal OFF position to either a RIGHT-ON position or a LEFT-ON position as described above, to activate a mechanical switch (not shown) sending one of two signals 40 (indicating three states) to a processor 38. In the OFF position, processor 38 provides no output signals so that neither of the left side turning lamps 46 nor the right side turning lamps 44 of the vehicle are illuminated. If the activation stalk 20 is moved upward by the driver to the RIGHT-ON position, the processor 38 provides an intermittently on signal to flash the right side lamps 44. Similarly, when the activation stalk 20 is forced downward to the LEFT-ON position, the processor 38 provides an intermittently on signal to flash the left side lamps 46. It is understood that the output from the microprocessor may be further amplified by a relay or transistor to provide suitable current for the lamps 44 and 46, as known in the art.

The touch pads 26, 28 may also be used to activate the turn signal lamps 44, 46. More particularly, driver contact or near contact with the upper touch pad 26 causes one of two signals 42 between the touch pads 26, 28 and the microprocessor 38 to cause the processor 38 to temporarily illuminate the left side lamps 46. Similarly, driver contact or near contact with the lower touch pad 28 causes the other of the two signals 42 between the touch pads 26, and 28 and the microprocessor to cause the processor 38 to temporarily illuminate the right side lamps 44. This functionality is particular advantageous for lane changes.

For example, for a left lane change, the driver may touch the upper touch pad 26 which causes a corresponding electrical signal to be transmitted to the processor 38. Preferably, the processor 38 executes a timing loop so that after a predefined number of turn signal flashes, e.g., three flashes, the processor 38 automatically cancels flash mode. Thus, the driver does not need to make a separate turn signal cancellation input to the turn signal activation stalk 20 to turn off the turn signal lamps. Contact or near contact with the lower touch pad 28 would similarly result in illumination of the right side lamps 44 for a right lane change.

In addition to lane changes, contact with the touch pads 26, 28 may be used to activate the respective turn signal lamps 44, 46 when the turn signal lamps 44, 46 cannot be otherwise activated conventionally. For example, with conventional turn signal systems, it is possible for the turn signal activation stalk to not remain in either of the ON positions if the steering wheel is at or near a fully rotated position. In these circumstances, a driver has had to manually hold the turn signal activation stalk in either the up or down position to cause illumination of the respective right and left turn signal lamps. The present invention allows the driver to tap either of the touch pads 26, 28 to cause illumination of the turn signal lamps rather than hold the turn activation stalk at a particular position.

Further, it is contemplated that the processor 38 may control illumination of the turn signal lamps 44, 46 resulting from an input to either of the touch pads 26, 28 based on the speed of the vehicle. For instance, for a lane change, contact with a touch pad results in flashing of the corresponding turn signal lamps for a specified time period or number of flashes. However, when the vehicle is at rest or moving at a speed below a given threshold, contact with a touch pad results in an indefinite flashing of the corresponding turn signal lamp until either the speed of the vehicle has exceeded the threshold or the driver has made a cancellation input, such as re-contacting the touch pad. This further embodiment will maintain flashing of the turn signal lamps when the vehicle is at a stop yet mechanical activation of the turn signal lamps is not possible, e.g., a (near) fully rotated steering wheel. Thus, in this further embodiment, the driver does not need to continually tap the touch pad to maintain flashing of the turn signal lamps.

An improved turn signal activation stalk 52 that is designed to overcome the mechanical lockout drawbacks of a conventional turn signal activation stalk is shown in FIG. 3. The turn signal activation stalk 52 has a stalk body 54 that is connected to the steering column 56 by a connector arm 58. The outer end of the stalk body 54 has a touch pad 60 similar in construction to the touch pads 26, 28 described with respect to FIG. 2. The connector end 62 opposite the stalk body 52 is pinned to a socket 64 that allows pivoting of the activation stalk 52 relative to the steering column 56.

Upward pivoting of the activation stalk 52 is limited by an upward stop 66 that is coupled to the steering column 56 and carries a first proximity switch or sensor 68. Downward pivoting of the activation stalk 52 is limited by a downward stop 70 that is also coupled to the steering column 56 and carries a second proximity switch or sensor 72. Upward movement of the activation stalk 52 toward the upward stop 66 is against a first spring 74 and downward movement of the activation stalk 52 toward the downward stop 70 is against a second spring 76. Springs 74, 76 bias the lever 52 centrally between the pair of stops 66, 70.

In operation, the driver moves the activation stalk 52 upward or downward to active the right side turn lamps 44 or the left side turn lamps 46, respectively. Rather than locking into place as is the case with conventional turn signal activation stalks, the activation stalk 52 automatically returns to its central position once the driver releases the activation stalk 52. The sensors 68, 72 sense the movement of the connector arm 58 and send an electrical signal to the processor 38, which activates switch 40 accordingly. Thus, for the right turn lamps 44 to begin to flash, the activation stalk 52 must be moved upward until the connector arm 58 is sensed by the proximity sensor 68. Once the connector 58 is sensed, the proximity sensor sends a corresponding electrical signal to the processor 38. Similarly, for the left turn lamps 46 to begin to flash, the activation stalk 52 must be moved downward until the connector arm 58 is sensed by the proximity sensor 72. The proximity sensor 72 then sends a corresponding electrical signal to the processor 38. Preferably, the upward or downward movement of the connector arm 58 is sensed before the connector arm moves against stop 66 or stop 70.

When the connector arm 58 hits either stop 66, 70, the driver releases the activation stalk 52 whereupon the activation stalk 52 is returned to its center position under the control of springs 74, 76. In contrast to conventional turn signal activation stalks, the turn signal lamps will continue to flash. To cancel flashing of the turn signal lamps, the driver taps touch pad 60. Thus, after completing a turn, the driver contacts with the touch pad 60, which sends an electrical signal to the processor 38 that is processed to return switch 40 to the OFF position 42. Alternately, the processor may cause switch 40 to return to the OFF position 42 after a specified time, e.g., twenty seconds. Alternately, or in addition, the processor may return the switch to the OFF position 42 to cancel flashing of the turn signal lamps after the vehicle speed has reached a specified velocity.

In one embodiment, the proximity sensors 68, 72 are Hall effect sensors, but it is contemplated that other types of sensors could be used to sense the position of the connector arm 58 of the turn signal activation stalk 52.

Further, it is contemplated that an audible signal beep could be emitted whenever the turn signal lamps are activated as activated by a signal from microprocessor 38 to audio transducer 50. Not only does such an audible signal confirm activation of the turn signal lamps, but the audible signal could also be repeated after a specified time period to remind the driver that flashing of the turn signal lamps has not been canceled.

As referenced above with respect to FIG. 1 and referring also to FIG. 4, the steering column 18 may also support a washer control activation stalk 30. The washer control activation stalk 30 is mounted to the steering column 18 in a known manner that allows the activation stalk to be pulled toward the driver as well as pivoted upward to various indexed positions defined relative to the steering wheel 10 each of which may provide a corresponding signal along line 40 to the microprocessor 38. In a conventional manner, when the activation stalk 30 is pulled forward by the driver, an electrical signal is transmitted to the processor 38 that in turn controls a motor 78 to move wiper blades 80 across the windshield of the vehicle. When the driver contacts or nearly contacts the touch pad 36, the touch pad 36 transmits an electrical signal along line 42 to the processor 38 to signal the driver's intent to activate the washer part of the wiper and washer system.

When the touch pad 36 is touched, the processor 38 causes fluid pump 82 to pump washer fluid from tank 84 through fluid conduits 86 and onto the windshield through nozzles 88. Fluid is sprayed onto the windshield only as a result of contact with the touch pad 36 which allows fluid to be sprayed independent of the position of the activation stalk 30. The invention thus allows a driver to spray washer fluid onto the windshield without simultaneously causing the wiper blades 80 to begin their reciprocating motion across the windshield.

The incorporation of the touch pad 36 into activation stalk 30 advantageously allows the driver to discretionally determine how much fluid is sprayed onto the windshield before the wiper blades begin to wipe. The driver can lightly press the touch pad 36, without pulling the lever 30, to begin the spraying of washer fluid onto the windshield. Washer fluid will continue as long as the driver maintains contact with the touch pad 36; although it is contemplated that a time-out feature could be used. When the driver wants the wiper blades to wipe clean the windshield, the driver pulls the activation stalk 30. If contact with the touch pad 36 is maintained, washer fluid will continue to be sprayed as the wiper blades 80 wipe across the windshield. When the activation stalk 30 is released, the spraying of washer fluid stops immediately and preferably the wipe action of the wiper blades continues for a specified time period or number of cycles.

It is understood that a Hall effect sensor or other type of sensory component may be used to detect when the activation stalk 30 is pulled toward the driver.

The combined mechanical and touch switch activation stalk 30 allows the driver to wet the windshield prior to starting the wiper blades. This will prevent scratching of the glass. Also the driver can pre-wet as much of the windshield as necessary to ensure that all of the wiped area is cleaned when the wipers are turned on.

Preferably, the touch pads described herein are capacitance switches. It is understood in the art that a capacitance switch detects a change in capacitance caused by proximity of the human hand to effect an electrical switching. Other touch switches making use of electrostatic or radiofrequency fields and other sensing techniques are well known in the art, and may alternately be used. For example, resistance based switches may be used.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A combined mechanical and touch switch apparatus for a vehicle having a selectively controllable system, comprising:
an activation stalk positioned proximate a steering wheel of the vehicle and having a touch sensor;
a mechanical switch system that senses motion of the activation stalk to provide a first control of the system; and
a touch switch system that senses touching of the touch sensor to provide a second control of the system.

2. The apparatus of claim 1 wherein the system is a turn signaling system having a first turning lamp and a second turning lamp, and wherein the activation stalk is movable between a default position and either a first position and a second position, and wherein the mechanical switch system energizes the first turning lamp when the activation stalk is moved from the default position to the first position and energizes the second turning lamp when the activation stalk is moved from the default position to the second position.

3. The apparatus of claim 2 wherein the mechanical switch system automatically returns the activation stalk to the default position upon counter-rotation of the steering wheel.

4. The apparatus of claim 2 further comprising a first return spring, a second return spring, a first stop defining the first position, and a second stop defining the second position, and wherein the mechanical switch system energizes the first lamp when the activation stalk is moved against the first return spring to a position proximate the first stop and energizes the second lamp when the activation stalk is moved against the second return spring to a position proximate the second stop.

5. The apparatus of claim 4 wherein the mechanical switch system maintains activation of either the first turning lamp or the second turning lamp when the activation stalk is returned to the default position.

6. The apparatus of claim 5 wherein the touch switch system cancels the activation of the first turning lamp or the second turning lamp in response to contact with the touch sensor.

7. The apparatus of claim 2 wherein the touch switch system activates one of the first lamp and the second lamp in response to contact with the touch sensor.

8. The apparatus of claim 7 wherein the one of the first lamp and the second lamp is activated for a time-limited duration in response to contact with the touch sensor.

9. The apparatus of claim 7 wherein the touch switch system activates the one of the first lamp and the second lamp in response to contact with the touch sensor when the activation stalk is in the default position.

10. The apparatus of claim 7 wherein the activation stalk has another touch sensor, wherein contact with a first touch sensor causes activation of the first lamp and contact with a second touch sensor causes activation of the second lamp.

11. The apparatus of claim 1 wherein the system is a wiper and washer system having a motor that causes activation of a wiper blade assembly and a pump that causes cleaning fluid to be dispensed onto a windshield of the vehicle, and wherein the mechanical switch system provides an activation input to the motor in response to movement of the activation stalk that causes the motor to move the wiper blade assembly.

12. The apparatus of claim 11 wherein the touch switch system provides an activation input to the pump in response to contact with the touch sensor that causes the pump to dispense washing fluid onto the windshield.

13. The apparatus of claim 12 wherein the touch system provides the activation input independent of movement of the activation stalk.

14. The apparatus of claim 12 wherein the input to the pump provided by the touch switch system further causes activation of a timer that places a limit on an activation time of the pump.

15. A switching device for controlling operation of a turn signal system of a vehicle, comprising:
a turn signal activation stalk attached proximate a steering column of the vehicle;
a first switch system sensing motion of the turn signal activation stalk to provide a first control of the turn signal system; and
a second touch switch system sensing a touching of the turn signal activation stalk to provide a second control of the turn signal system.

16. The device of claim 15 wherein the second control causes a temporary activation of the turn signal system.

17. The device of claim of claim 16 wherein the second touch switch system includes a first touch pad and a second touch pad coupled to the turn signal activation stalk, and wherein the second touch system causes a first set of turning lamps of the turn signal system to be temporarily activated in response to contact with the first touch pad and causes a second set of turning lamps of the turn signal system to be temporarily activated in response to contact with the second touch pad.

18. The device of claim 17 wherein the temporary activation includes three flashes of either the first set or the second set of turning lamps.

19. The device of claim 15 wherein the first control causes activation of the turn signal system and the second control causes deactivation of the turn signal system.

20. A switch apparatus for a vehicular windshield washing system, which includes a motor that moves wiper blades across an exterior surface of a windshield of a vehicle and pump that causes washer fluid to be sprayed onto the windshield, the switch apparatus comprising:
an activation stalk mounted proximate a steering wheel of the vehicle;
a first touch switch system that senses contact with the stalk to initiate a spray of washing fluid onto the windshield; and
a second switch system that senses motion of the stalk to activate motion of the wiper blades independently of any sensed contact with the stalk.

21. The apparatus of claim 20 wherein the first touch switch system includes a capacitive touch pad coupled to the activation stalk.

22. The apparatus of claim 21 wherein contact with the touch pad causes the first touch switch system to initiate a pre-defined number of spray iterations by the vehicular windshield washing system.
